(19) United States
(12) Patent Application Publication
(10) Pub. No.: US 2012/0242784 A1
(43) Pub. Date: Sep. 27, 2012

(54) IMAGE PROCESSING METHOD, CAMERA MODULE, AND PHOTOGRAPHING METHOD

(75) Inventor: Takayuki OGASAHARA, Kanagawa (JP)

(73) Assignee: Kabushiki Kaisha Toshiba, Tokyo (JP)

(21) Appl. No.: 13/352,891

(22) Filed: Jan. 18, 2012

(30) Foreign Application Priority Data
Mar. 23, 2011 (JP) 2011-064546

(51) Int. Cl. H04N 5/225

(52) U.S. Cl. 348/36; 348/E05.024

(57) ABSTRACT

According to one embodiment, an image processing method includes at least one of an alignment adjustment and a resolution reconstruction in image processing on an object image. The object image is imaged by an imaging optical system including a fisheye lens. In the alignment adjustment, a coordinate transformation on the object image is performed. The coordinate transformation includes a correction of displacement in the object image caused by an individual difference of the fisheye lens. The resolution reconstruction is performed on the object image based on lens characteristics of the fisheye lens.

### CROSS-REFERENCE TO RELATED APPLICATIONS

This application is based upon and claims the benefit of priority from Japanese Patent Application No. 2011-064546, filed on Mar. 23, 2011; the entire contents of all of which are incorporated herein by reference.

### FIELD

Embodiments described herein relate generally to an image processing method, a camera module, and a photographing method.

### BACKGROUND

Conventionally, a camera module provided with a fisheye lens is used for realizing a wide range of view. For the purpose of reducing an aberration and the like, the fisheye lens is required to have accurate processing on the lens by itself, an accurate assembly with other components, and the like. A manufacturing error, an assembly error, optical performance and the like of the fisheye lens are bound to greatly affect an image quality. Due to this, there are issues in obtaining a high quality image such as a decrease in a yield of the camera module, an increase in manufacturing cost for suppressing the manufacturing error and the assembly error of the fisheye lens.

### BRIEF DESCRIPTION OF THE DRAWINGS

FIG. 1 is a block diagram illustrating a schematic configuration of a camera module of a first embodiment;

FIG. 2 is a block diagram illustrating a configuration of a digital camera that is an electric apparatus provided with the camera module illustrated in FIG. 1;

FIG. 3 is a flow chart for explaining a procedure of signal processing by a signal processing section of an ISP;

FIG. 4 is a block diagram illustrating a schematic configuration of an imaging circuit;

FIG. 5 is a flow chart for explaining a procedure of setting an alignment adjustment correction coefficient for an alignment adjustment in an alignment adjustment section;

FIG. 6 is a diagram illustrating an example of an alignment adjusting chart;

FIG. 7 is a flow chart for explaining a procedure of setting a deconvolution matrix for a resolution reconstruction in a resolution reconstruction section;

FIG. 8 is a block diagram illustrating a schematic configuration of a camera module of a second embodiment; and

FIG. 9 is a block diagram illustrating a schematic configuration of a signal processing section provided in an ISP.

### DETAILED DESCRIPTION

In general, according to one embodiment, an image processing method includes in image processing on an object image at least one of an alignment adjustment and a resolution reconstruction. The object image is imaged by an imaging optical system including a fisheye lens. In the alignment adjustment, a coordinate transformation is performed on the object image. The coordinate transformation includes a correction of displacement in the object image caused by an individual difference of the fisheye lens. The resolution reconstruction is performed on the object image based on lens characteristics of the fisheye lens.

Exemplary embodiments of an image processing method, a camera module, and a photographing method will be described below in detail with reference to the accompanying drawings. The present invention is not limited to the following embodiments.

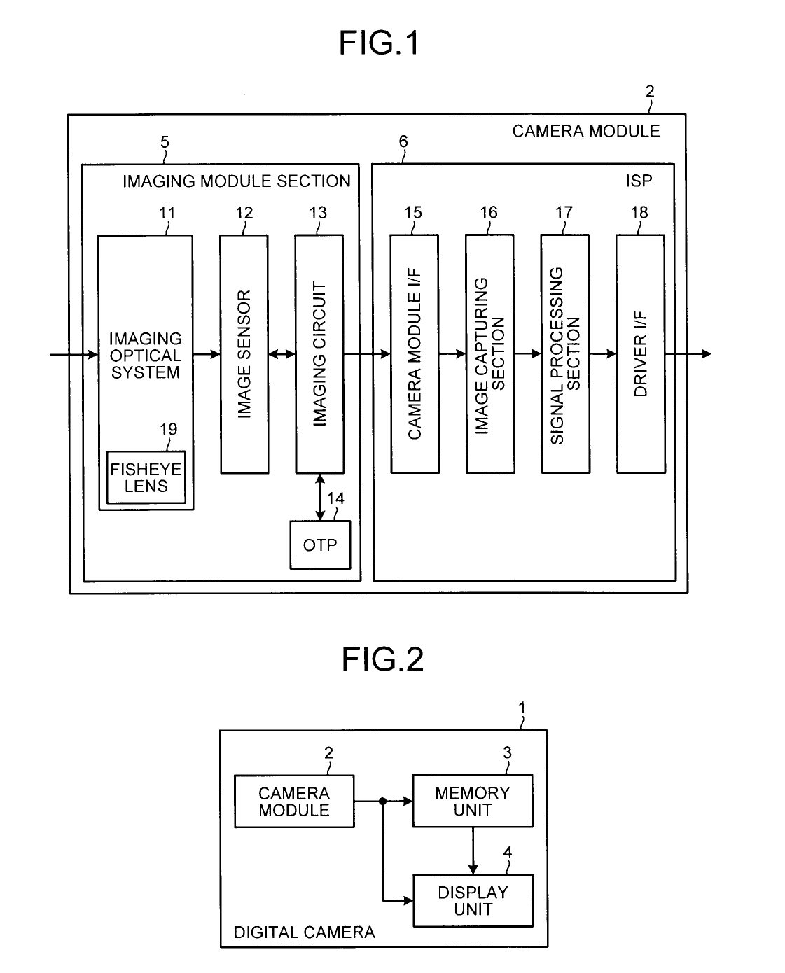

FIG. 1 is a block diagram illustrating a schematic configuration of a camera module of a first embodiment. FIG. 2 is a block diagram illustrating a configuration of a digital camera that is an electric apparatus provided with the camera module illustrated in FIG. 1.

A digital camera 1 includes a camera module 2, a memory unit 3, and a display unit 4. The camera module 2 images an object image. The memory unit 3 stores the image taken by the camera module 2. The display unit 4 displays the image taken by the camera module 2. The display unit 4 is for example a liquid crystal display.

The camera module 2 outputs image signals to the memory unit 3 and the display unit 4 by imaging the object image. The memory unit 3 outputs the image signals to the display unit 4 according to an operation by a user and the like. The display unit 4 displays an image according to the image signals input from the camera module 2 or the memory unit 3. The camera module 2 may be applied to an electric apparatus other than the digital camera 1; for example, such as a cellular phone with a camera.

The camera module 2 includes an imaging module section 5 and an image signal processor (ISP) 6. The imaging module section 5 includes an imaging optical system 11, an image sensor 12, an imaging circuit 13, and an OTP (one time programmable memory) 14.

The imaging optical system 11 takes in light from an object to the image sensor 12. The imaging optical system 11 images the object image in the image sensor 12. The imaging optical system 11 is configured by including a fisheye lens 19. The image sensor 12 converts light taken in by the imaging optical system 11 to signal charges. The image sensor 12 functions as an imaging section that images the object image.

The imaging circuit 13 drives the image sensor 12. Further, the imaging circuit 13 processes the image signals from the image sensor 12. The imaging circuit 13 generates analog image signals by taking in signal values for R (red), G (green), and B (blue) in an order corresponding to the Bayer arrangement. The imaging circuit 13 converts the obtained image signals from analog format to digital format. The OTP 14 retains parameters for the signal processing of the image signals. The OTP 14 functions as a parameter retaining section.

The ISP 6 includes a camera module I/F (interface) 15, an image capturing section 16, a signal processing section 17, and a driver I/F (interface) 18. A RAW image obtained by the imaging module 5 imaging the image is captured in the image capturing section 16 from the camera module I/F 15.

The signal processing section 17 performs signal processing on the RAW image captured by the image capturing section 16. The driver I/F 18 outputs the image signals that have undergone the signal processing by the signal processing section 17 to a display driver that is not illustrated. The display driver displays the image imaged by the camera module 2.

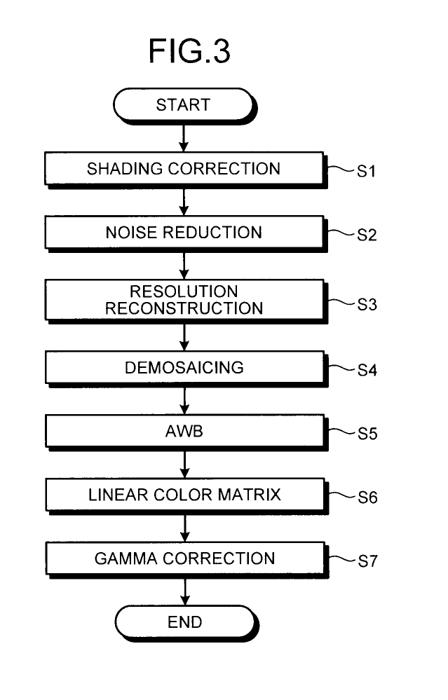

FIG. 3 is a flow chart for explaining a procedure of signal processing by the signal processing section of the ISP. The signal processing by the camera module 2 is roughly classified into the processing by the signal processing section 17 of the ISP 6 and the processing by the imaging circuit 13. The imaging circuit 13 and the signal processing section 17 function as an image processing section (image processing device) that performs the signal processing on the image signals obtained by the image sensor 12 imaging the object image.

The signal processing section 17 (see FIG. 1) performs a shading correction on the RAW image obtained by the camera module 2 imaging the image (step S1). The signal processing section 17 corrects unevenness in brightness caused by an intensity difference between a center portion and a peripheral portion of the imaging optical system 11 (see FIG. 1) by the shading correction.

The signal processing section 17 performs a noise reduction to remove noises such as a fixed pattern noise, a dark current noise, and a shot noise (step S2), and a resolution reconstructing process (step S3). Next, the signal processing section 17 performs a pixel interpolating process (demosaicing) on the digital image signals transmitted in the order of the Bayer arrangement (step S4). In the demosaicing, by the interpolating process of the image signals obtained by imaging, sensitivity level values of insufficient color components are generated. The signal processing section 17 composites a color bit map image by the demosaicing.

The signal processing section 17 performs an automatic control of white balance (automatic white balance control; AWB) on the color image (step S5). Further, the signal processing section 17 performs linear color matrix processing to obtain a color reproducibility (step S6), and a gamma correction for correcting chroma and brightness of the image to be displayed on the display and the like (step S7).

Note that, the procedure of the signal processing in the ISP 6 described in the present embodiment is a mere example, and other processing may be added, omittable processing may be omitted, and the order thereof may be changed as needed. Each processing may be performed by either the camera module 2 or the ISP 6, and may be performed by them by taking partial responsibilities.

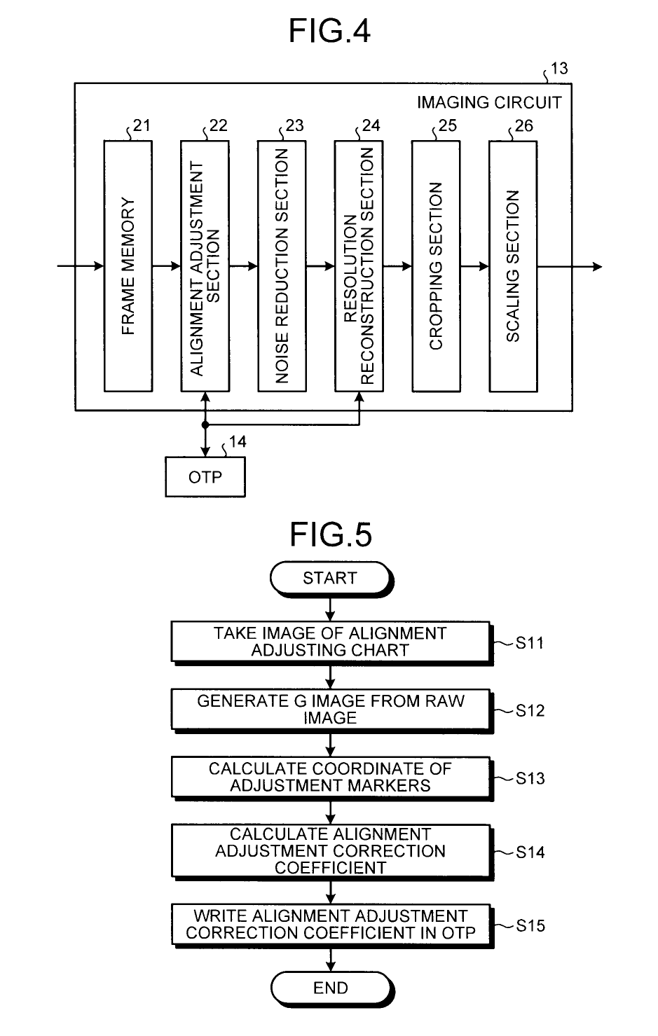

FIG. 4 is a block diagram illustrating a schematic configuration of the imaging circuit. The imaging circuit 13 includes a frame memory 21, an alignment adjustment section 22, a noise reduction section 23, a resolution reconstruction section 24, a cropping section 25, and a scaling section 26.

The frame memory 21 temporarily stores the object image obtained by the imaging by the image sensor 12. The object image obtained by using the fisheye lens 19 has distortion such that a peripheral portion of the image shrinks at a greater degree. The alignment adjustment section 22 simultaneously performs a coordinate transformation to restore coordinate axes having great distortion peculiar to the fisheye lens 19 to rectangular grid shape and a coordinate transformation to correct displacement of the object image caused by an individual difference of the fisheye lens 19.

The aforesaid processing for the alignment adjustment requires image data of the object image of a relatively wider range than in cases with other image processing. Due to this, the imaging circuit 13 employs the frame memory 21, which has larger capacity than a line memory and the like, as a device to store the image data to be used in the signal processing.

The individual difference of the fisheye lens 19 is defined to be a difference that may be caused for each fisheye lens 19 by a manufacturing error of the fisheye lens 19, an assembly error of the fisheye lens 19 in the camera module 2, and the like. The alignment adjustment section 22 performs the coordinate transformation on the object image by using the alignment adjustment correction coefficient that is predeterminedly stored in the OTP 14. Note that, the alignment adjustment section 22 will suffice by at least correcting the displacement of the object image caused by the individual difference of the fisheye lens 19; and the coordinate transformation for restoring the distortion peculiar to the fisheye lens 19 may appropriately be omitted.

The noise reduction section 23 removes noises such as a fixed pattern noise, a dark current noise, and a shot noise from the object image. The resolution reconstruction section 24 performs the resolution reconstruction on the object image based on lens characteristics that the fisheye lens 19 has, such as a color scale aberration, an axis color aberration, and an amount of blur. As the lens character, for example a point spread function (PSF) is used. The PSF is estimated, for example, by using methods such as a least-squares method.

The resolution reconstruction section 24 reconstructs an image with decreased blur by multiplying a deconvolution matrix of the PSF, for example. The deconvolution matrix of the PSF is predeterminedly stored in the OTP 14. An effect of the resolution reconstruction depends on an algorithm used for the reconstruction. The resolution reconstruction section 24, for example, uses a Richardson-Lucy method to reconstruct an image that is similar to the original object image. The resolution reconstruction section 24 is especially effective for correcting the resolution that is deteriorated at the peripheral portion of the object image by the use of the fisheye lens 19.

The cropping section 25 performs cropping processing to cut out the object image according to a desired magnification. The scaling section 26 performs scaling processing of the object image according to a desired output size.

FIG. 5 is a flow chart for explaining a procedure of setting the alignment adjustment correction coefficient for the alignment adjustment in the alignment adjustment section. The setting of the alignment adjustment correction coefficient is performed in a process of manufacturing the camera module 2, for example. In step S11, the camera module 2 takes an image of an alignment adjusting chart.

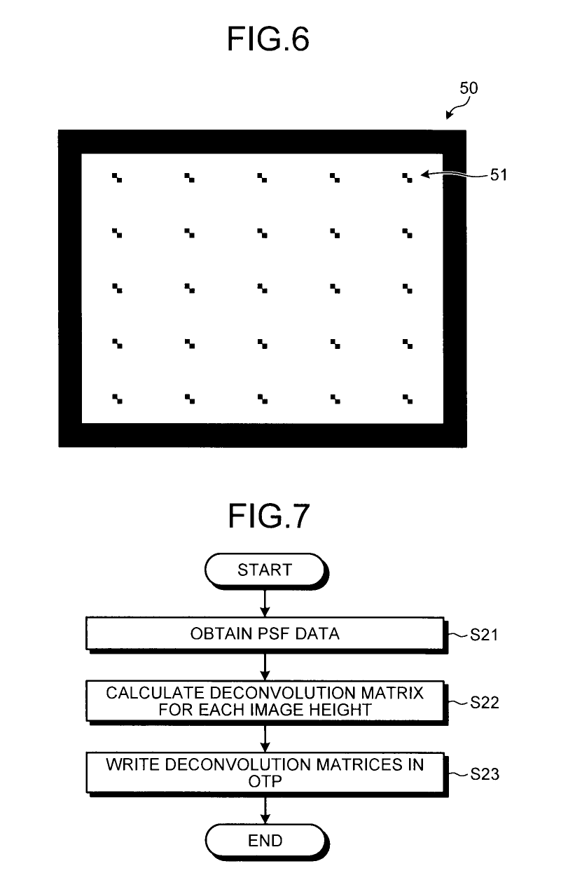

FIG. 6 is a diagram illustrating an example of the alignment adjusting chart. A plurality of adjustment markers 51 is denoted in the alignment adjusting chart 50. The adjustment markers 51 are arranged in a matrix of five pieces in a vertical direction and five pieces in a horizontal section, for example. The number of adjustment markers 51 in the alignment adjusting chart 50 may appropriately be changed.

The adjustment markers 51 are, for example, a mark in which two black squares having their corners met, and a position where the corners meet is to be a coordinate of the adjustment marker 51. The adjustment markers 51 will suffice so long as their position on the adjusting chart 50 can be identified; and they may have any shapes. Further, the arrangement of the adjustment markers 51 may appropriately be changed. For example, in a case where there especially is an area to which imaging with a high detail is desired, many of the adjustment markers 51 may be arranged within that area.

In step S12, the camera module 2 obtains a G image generated based on the object image obtained in step S11. The G image is an image composed of the signals of G, among R, G, and B. In the image sensor 12, as for pixels for R and pixels for B, signal values for G are generated by interpolating signal values of surrounding pixels for G. Note that, in cases of imaging under low illumination and a sensitivity of the image sensor 12 being low, the G image may be generated after having performed the noise reduction.

In step S13, the camera module 2 obtains the coordinate of each adjustment marker 51 calculated from the G image. In step S14, the camera module 2 obtains the alignment adjustment correction coefficient by a calculation using the coordinates of the adjustment markers 51. In step S15, the camera module 2 writes the alignment adjustment correction coefficient obtained in step S14 to OTP 14.

The alignment adjustment correction coefficient is a coefficient in a matrix calculation. The alignment adjustment correction coefficient is acquired from a formula as in below by the least-squares method, for example.

Y=kX

k=YX^{t}[XX^{t}]⁻¹

Note that k is the alignment adjustment correction coefficient, Y is the coordinates of the adjustment markers 51 calculated in step S13, and X is a coordinate that is predeterminedly set as a reference. X^{t} is a transverse matrix of X. [XX^{t}]⁻¹ is a transverse matrix of XX^{t}. The alignment adjustment correction coefficient may be acquired by algorithms other than the least-squares method, such as a nonlinear optimization method.

The alignment adjustment section 22 reads the alignment adjustment correction coefficient from the OTP 14 each time the image sensor 12 images the object image. Further, the alignment adjustment section 22 performs the coordinate transformation using the alignment adjustment correction coefficient read from the OTP 14 on the RAW image obtained by the image sensor 12.

The alignment adjustment section 21 performs the coordinate transformation by a calculation as shown below, for example. Note that, kᵢⱼ is the alignment adjustment correction coefficient, (x, y) is the coordinate before correction, and (x′, y′) is the coordinate after the correction.

$$[ \begin{matrix}{x}^{′} \\ {y}^{′} \\ 1\end{matrix} ] = [ \begin{matrix}{k}_{11} & {k}_{12} & {k}_{13} \\ {k}_{21} & {k}_{22} & {k}_{23} \\ 0 & 0 & 1\end{matrix} ] \cdot [ \begin{matrix}x \\ y \\ 1\end{matrix} ]$$

The camera module 2 becomes possible to suppress the displacement in the object image caused by the manufacturing error and the assembly error of the fisheye lens 19 by the coordinate transformations of the alignment adjustment section 22. Note that, aside from performing the one-time coordinate transformation by the matrix calculations, the alignment adjustment section 22 may perform the coordinate transformation on respective divided parts by a calculation using an alignment adjustment correction coefficient that is appropriately changed according to an image height. The image height is, in assuming a vertical axis that is vertical to an optical axis of the lens, a distance from an intersection of the aforesaid vertical axis and the optical axis along the aforesaid vertical axis.

The alignment adjustment section 22 may, for example, perform a coordinate transformation by referencing a lookup table instead of the matrix calculation. The alignment adjustment correction coefficient is not limited to the case of the calculation having performed the generation of the G image from the RAW image. The alignment adjustment correction coefficient may, for example, be calculated based on a G image extracted from a color bit map image.

FIG. 7 is a flow chart for explaining a procedure of setting the deconvolution matrix for the resolution reconstruction in the resolution reconstruction section. The setting of the deconvolution matrix is performed, for example, in the process of manufacturing the camera module 2.

In step S21, the camera module 2 takes an image of a test chart. The camera module 2 obtains PSF data by processing the taken data obtained by the image-taking. The PSF data is acquired, for example, by assuming a reference image in which no blur has occurred, and measuring a degree of blur in an observed image relative to the reference image. The test chart virtually divides an imaging surface of the image sensor 12, for example, into nine areas with three rows and three columns, and is a point image chart configured of a plurality of point images.

In step S22, the camera module 2 obtains a deconvolution matrix for each image height by a calculation based on the PSF data obtained in step S21. In step S23, the camera module 2 writes the deconvolution matrices obtained in step S22 to the OTP 14. The resolution reconstruction section 24 reads the deconvolution matrices each time the image sensor 12 images the object image, and multiplies them to the RAW data of the object image.

The method of the resolution reconstruction by the multiplication of the deconvolution matrices is based on a logic that the observed image can be expressed as a convolution of a true image and a PSF function that is a cause of deterioration in the image. The camera module 2 can suppress the blur in the object image caused by the lens characteristics of the fisheye lens 19 by the multiplication of the deconvolution matrices in the resolution reconstruction section 24. The resolution reconstruction section 24 may, for example, perform a data transformation by referencing a lookup table instead of the matrix calculation.

By including the alignment adjustment section 22 and the resolution reconstruction section 24, the camera module 2 suppresses influence of the manufacturing error, the assembly error, the optical performance, and the like of the fisheye lens 19 to the image quality. Due to this, it becomes possible for the camera module 2 to obtain an image with wide angle and high quality by using the fisheye lens 19.

The camera module 2 is not limited to those provided with both the alignment adjustment section 22 and the resolution reconstruction section 24. The camera module 2 may simply be provided with at least one of the alignment adjustment section 22 and the resolution reconstruction section 24. The image processing method and the photographing method according to the present embodiment may simply perform at least one of the alignment adjustment and the resolution reconstruction on the object image imaged by using the imaging optical system 11 including the fisheye lens 19. Due to this, the camera module 2 suppresses the influence of at least one of the individual difference, the optical performance, and the like of the fisheye lens 19, and can obtain satisfactory image quality.

Note that, the procedure of the signal processing in the imaging circuit 13 described in the present embodiment is a mere example, and other processing may be added, omittable processing may be omitted, and the order thereof may be changed as needed.

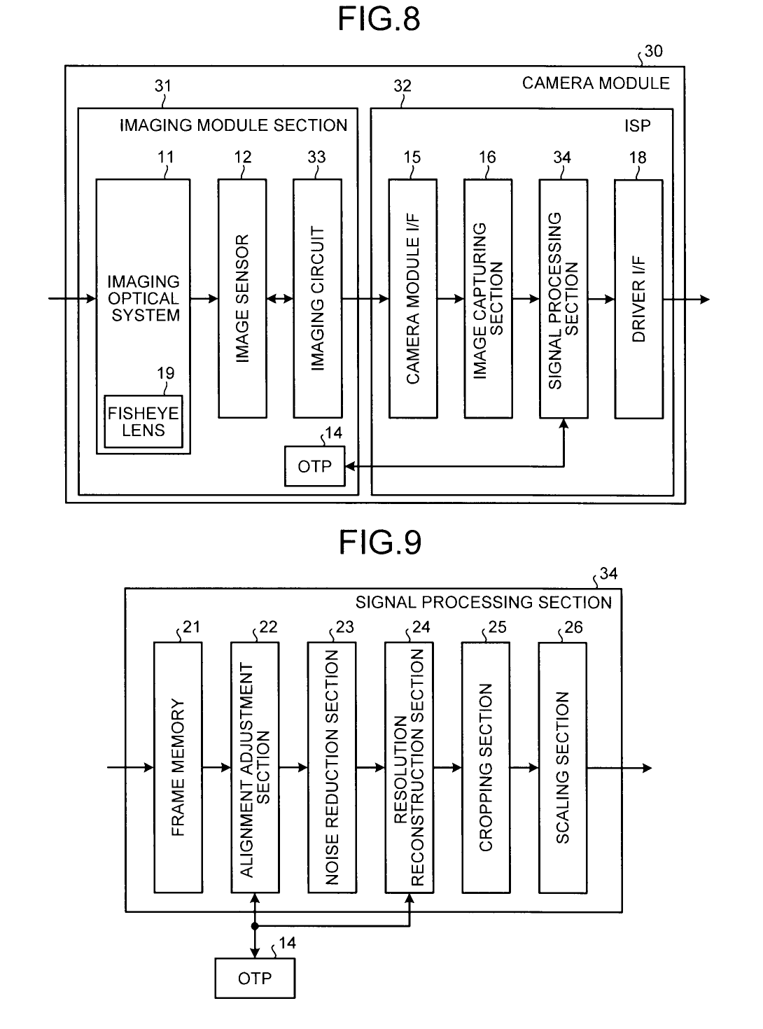

FIG. 8 is a block diagram illustrating a schematic configuration of a camera module of a second embodiment. FIG. 9 is a block diagram illustrating a schematic configuration of a signal processing section provided in an ISP. Parts identical to the first embodiment will be given the same reference signs, and overlapping description will not be repeated.

A camera module 30 includes an imaging module section 31 and an ISP 32. The imaging module section 31 includes the imaging optical system 11, the image sensor 12, an imaging circuit 33, and the OTP 14.

The imaging circuit 33 drives the image sensor 12, and processes image signals from the image sensor 12. The imaging circuit 33 generates analog image signals by taking in signal values for R, G, and B in an order corresponding to the Bayer arrangement. The imaging circuit 33 converts the obtained image signals from analog format to digital format.

The ISP 32 includes the camera module I/F 15, the image capturing section 16, a signal processing section 34, and the driver I/F 18. The signal processing section 34 performs the respective processes illustrated in FIG. 3 on a RAW image captured in the image capturing section 16, and also performs thereon the same processes as in the imaging circuit 13 of the first embodiment (see FIG. 4).

The signal processing section 34 includes the frame memory 21, the alignment adjustment section 22, the noise reduction section 23, the resolution reconstruction section 24, the cropping section 25 and the scaling section 26. The alignment adjustment section 22 reads the alignment adjustment correction coefficient from the OTP 14 of the imaging module section 31, and performs a coordinate transformation on the RAW image or the bit map image. The resolution reconstruction section 24 reads the deconvolution matrix from the OTP 14 of the imaging module section 31, and multiplies the same to the RAW data or the bit map data of the object image.

In the present embodiment also, similar to the first embodiment, the camera module 30 can obtain an image with wide angle and high quality by using the fisheye lens 19. The signal processing described in the first and second embodiments may be performed by one of the imaging circuits 13, 33 and the signal processing sections 17, 34, or may be performed by both of them by taking partial responsibilities. The partial responsibilities to be taken for the signal processing by the imaging circuits 13, 33 and the signal processing sections 17, 34 may appropriately be determined, for example according to restrictions on the respective circuit scales. The camera modules 2, 30 of the first and second embodiments may be applied to an electric apparatus other than the digital camera 1; for example, they may be applied to a cellular phone with a camera.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing method in image processing of an object image imaged by using an imaging optical system including a fisheye lens, the method including at least one of:
an alignment adjustment that performs on the object image a coordinate transformation including a correction of displacement in the object image caused by an individual difference of the fisheye lens; and
a resolution reconstruction on the object image based on lens characteristics of the fisheye lens.

2. The image processing method according to claim 1, wherein
the imaged object image is stored in a frame memory, and
at least one of the alignment adjustment and the resolution reconstruction is performed on the object image read from the frame memory.

3. The image processing method according to claim 1, wherein
an alignment adjustment correction coefficient for the alignment adjustment is predeterminedly retained, and
the alignment adjustment is performed by reading the retained alignment adjustment correction coefficient each time the object image is imaged.

4. The image processing method according to claim 3, wherein
the alignment adjustment correction coefficient is calculated and retained in a process of manufacturing a camera module that is to image the object image.

5. The image processing method according to claim 1, wherein
a point spread function for the resolution reconstruction is predeterminedly retained, and
the resolution reconstruction is performed by reading the retained point spread function each time the object image is imaged.

6. The image processing method according to claim 5, wherein
the point spread function is calculated and retained in a process of manufacturing a camera module that is to image the object image.

7. A camera module comprising:
an imaging section that images an object image;
an imaging optical system that takes in light from an object to the imaging section; and
an image processing section that performs signal processing on image signals obtained by the imaging section imaging the object image,
wherein the imaging optical system is configured to include a fisheye lens, and
the image processing section includes at least one of an alignment adjustment section that performs as an alignment adjustment on the object image a coordinate transformation including a correction of displacement in the object image caused by an individual difference of the fisheye lens, and
a resolution reconstruction section that performs a resolution reconstruction on the object image based on lens characteristics of the fisheye lens.

8. The camera module according to claim 7, further comprising a frame memory that stores the imaged object image,
wherein the image processing section performs on the object image read from the frame memory at least one of the alignment adjustment by the alignment adjustment section and the resolution reconstruction by the resolution reconstruction section.

9. The camera module according to claim 7, further comprising a parameter retaining section that retains an alignment adjustment correction coefficient for the alignment adjustment,
wherein the alignment adjustment section performs the alignment adjustment by reading the retained alignment adjustment correction coefficient from the parameter retaining section each time the imaging section images the object image.

10. The camera module according to claim 9, wherein
the parameter retaining section retains the alignment adjustment correction coefficient calculated in a process of manufacturing the camera module.

11. The camera module according to claim 7, further comprising a parameter retaining section that retains a point spread function for the resolution reconstruction,
wherein the resolution reconstruction section performs the resolution reconstruction by reading the point spread function from the parameter retaining section each time the imaging section images the object image.

12. The camera module according to claim 11, wherein
the parameter retaining section retains the point spread function calculated in a process of manufacturing the camera module.

13. A photographing method including:
imaging an object image by using an imaging optical system including a fisheye lens; and
performing image processing of the object image,
wherein the image processing includes at least one of an alignment adjustment that performs on the object image a coordinate transformation including a correction of displacement in the object image caused by an individual difference of the fisheye lens, and a resolution reconstruction on the object image based on lens characteristics of the fisheye lens.

14. The photographing method according to claim 13, wherein
the imaged object image is stored in a frame memory, and
at least one of the alignment adjustment and the resolution reconstruction is performed on the object image read from the frame memory.

15. The photographing method according to claim 13, wherein
an alignment adjustment correction coefficient for the alignment adjustment is predeterminedly retained, and
the alignment adjustment is performed by reading the retained alignment adjustment correction coefficient each time the object image is imaged.

16. The photographing method according to claim 15, wherein
the alignment adjustment correction coefficient is calculated and retained in a process of manufacturing a camera module that is to image the object image.

17. The photographing method according to claim 13, wherein
a point spread function for the resolution reconstruction is predeterminedly retained, and
the resolution reconstruction is performed by reading the retained point spread function each time the object image is imaged.

18. The photographing method according to claim 17, wherein
the point spread function is calculated and retained in a process of manufacturing a camera module that is to image the object image.
